(19) United States
(12) Patent Application Publication
(10) Pub. No.: US 2025/0272689 A1
(43) Pub. Date: Aug. 28, 2025

(54) AUGMENTED RESPONSES TO RISK INQUIRIES

(71) Applicant: SardineAI Corp., Miami, FL (US)

(72) Inventors: Thomas Randal Todd, Pittsburgh, PA (US); Suhail Ranger, Ahmedabad (IN); Malcom Li, Richmond Hill (CA); Bino John Thomas, Saint Johns, FL (US)

(21) Appl. No.: 18/589,338

(22) Filed: Feb. 27, 2024

(51) Int. Cl. G06Q 20/40

(52) U.S. Cl. CPC G06Q 20/4016

(57) ABSTRACT

The present technology includes solutions for providing risk insights and/or other responses augmented by retried and/or interpreted data. An example method includes receiving, by a risk insights system from an inquiring entity, an inquiry associated with a transaction by a subject entity, wherein the transaction is associated with a risk score; determining, by the risk insights system, one or more factors contributing to the risk score; providing, by the risk insights system, the one or more factors to a machine learning model, wherein the machine learning model is configured to receive the one or more factors and output a response based on the one or more factors, wherein the response is in a format responsive to the inquiry; and output, by the risk insights system, the response to the inquiring entity. Systems and non-transitory computer-readable media are also provided.

### TECHNICAL FIELD

The present technology pertains to providing risk insights to a particular transaction and/or subject entity, and more particularly to, receiving an inquiry by a chatbot interface configured to communicate the inquiry with a large language model to interpret the inquiry and trigger a workflow based on an interpreted intent.

### BACKGROUND

Fraud and other malicious activities continue to plague transactions taking place over a network. In fact, such activities are becoming increasingly sophisticated making it harder for service providers to detect. For this reason, some service providers may choose to leverage a service that can provide risk insights into transactions and/or identities of the users performing transactions. Such a risk insights service can have access to a greater number of transactions, have visibility into transactions by a particular user across different service providers, and can be generally more nimble in reacting to new threat variants and types of threats than an individual service provider that might specialize in particular transactions.

Such service providers may also desire to understand why a particular transaction has a particular risk score, was classified as a success or failure, or some other transaction insights. These service providers would need to communicate with the risk insights service to obtain these transaction insights. Currently, this would require an operator of the service provider to directly communicate with personnel of the risk insights service. However, billions of transactions occur daily, which can easily overwhelm communications between the service providers and the risk insights service. This issue is further exacerbated by the fact that the type of data used by the risk insights service can be complex and difficult to understand by a layperson. In other words, the personnel of the service providers and the risk insights service need to be trained to understand and interpret data associated with the transactions.

Even when users are trained to understand the data associated with the transactions, the users would need to communicate the data to the other party without providing confidential information. Consequently, a large number of trained personnel must be available to communicate across entities with little room for error for a service provider to understand the reasons for a failed transaction.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a schematic block diagram of an example environment having an inquiring entity submitting a query to an example risk insights service in accordance with some aspects of the present technology.

FIG. 2 illustrates an example system for frictionless interactions between a user and a service in accordance with some aspects of the present technology.

FIG. 3 illustrates a schematic block diagram of an example fraud insight system in accordance with some aspects of the present technology.

FIG. 4 illustrates a schematic block diagram of an example fraud insight system in accordance with some aspects of the present technology.

FIG. 5 illustrates a method for providing risk insights in accordance with some aspects of the present technology.

FIG. 6 illustrates an example of a deep learning neural network that can be used to implement a perception module and/or one or more validation modules in accordance with some aspects of the present technology.

FIG. 7 illustrates an aspect of the subject matter in accordance with some aspects of the present technology.

FIG. 8 shows an example of a system for implementing some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

Fraud and other malicious activities continue to plague transactions taking place over a network. In fact, such activities are becoming increasingly sophisticated making it harder for service providers to detect. For this reason, some service providers may choose to leverage a service that can provide risk insights into transactions and/or identities of the users performing transactions. Such a risk insights service can have access to a greater number of transactions, have visibility into transactions by a particular user across different service providers, and can be generally more nimble in reacting to new threat variants and types of threats than an individual service provider that might specialize in particular transactions.

While a risk insights service offers significant advantages in identifying risky transactions (e.g., where a chance of fraud is somewhat higher), it can be challenging for service providers to ascertain why particular transactions are flagged or otherwise indicated as risky. For example, a risk insights service might provide a risk score for a transaction to the service provider, but the service provider may not understand why the transaction was flagged and/or how the score was calculated. The transaction provider might need to understand such details to provide customer service to a customer whose transaction did not proceed or to evaluate whether the transaction can still proceed even in view of the increase risk identified by the risk insights service. Communications between the transaction provider and the risk insights service can be further complicated by various regulations governing the type of data that is allowed to be used and/or shared between entities.

Thus, the present technology provides solutions for providing additional risk insights and/or other responses augmented with retrieved and/or interpreted data. More specifically, the present technology provides a system configured to receive queries from entities, such as a subject entity performing transaction and/or an inquiring entity (e.g., a service provider). The system can interpret (e.g., by a large language model), the inquiry and determine an intent of the inquiry. The determined intent can be used to trigger a workflow to retrieve data relevant to the inquiry. For example, the workflow can identify databases that contain transactional data and rules for determining risk for transactions. A machine learning model can be configured to retrieve and/or otherwise perform the workflows and make determinations based on the retrieved data.

Additionally, the determinations can be provided to a large language model that is configured to format the retrieved data and/or determinations into a response that is responsive to the inquiry. The response can then be provided to the entity providing the query. In some embodiments, the inquiry is received through a chatbot interface. The chatbot interface can be a part of a risk insights system that includes the machine learning model, the large language model, the databases, and/or combinations thereof. In some embodiments, the chatbot interface can be a part of the service providers, such that subject entities can ask a chatbot of the service provider why a transaction was denied. The chatbot interface of the service provider can be configured to communicate with the risk insights system and leverage the machine learning model, the large language model, a chatbot interface of the risk insights system, the databases, and/or any combination thereof to provide a response to the subject entity.

The present technology improves efficiency of operations and can reduce excessive communications. For example, both skilled and unskilled users may continuously attempt to retry a transaction when the transaction fails, which utilizes resources for every attempt. Such additional attempts would therefore waste bandwidth, compute, electricity, and other such resources. Similarly, even skilled users that have knowledge of various different application programming interfaces (APIs) might utilize an extraneous amount of API calls in an attempt to locate an answer for a query, which would again waste an excessive amount of resources. Additionally, some type of data and information may be regulated, confidential, or otherwise restricted. Some human users may inadvertently provide such confidential information to another entity.

On the other hand, the chatbot of the present technology improves the efficiency of these operations by providing an easily digestible communication platform to receive queries, interpret the queries, determine and execute a proper workflow to address the query, and provide the relevant output in a format that is easily digestible by the user. The large language model facilitates interpretation of received queries. The chatbot can communicate with and has knowledge of the various databases, which improves the efficiency in collecting relevant information for the queries.

Additionally, the present technology reduces the likelihood of transmitting confidential or otherwise restricted information between entities by using workflows that exclude the retrieval, transmittal, or communication of such information. For example, the chatbot can identify confidential information that should not be transmitted or otherwise provided to other entities and avoid utilizing such information. After collecting the relevant information, the chatbot can leverage the large language model to generate a communication to the user in a format that the user can understand and/or in a format that answers the query.

The chatbot can address follow up questions since the chatbot has already gathered the relevant information associated with the query. In other words, the chatbot reduces usage of resources because the chatbot would not need to retrieve relevant information for the query again by reducing a frequency and/or number of transactions with the various databases.

By leveraging the large language model, the chatbot improves user experience. For example, answers for queries can often include a large amount of data, rules, and other complicated information. The complexities for the content can make the answer difficult to read and/or understand. Some systems utilize human-readable formats, such as JavaScript Object Notation (JSON), which can return data in a format that can be understood by a human. However, these formats are not always easy to understand. For example, developers may be able to understand JSON outputs, but a lay person may have difficulties parsing the information from headers and payloads of the JSON file.

In contrast, the present technology teaches using a large language model that is configured to parse and interpret the collected information and subsequently generate a more understandable answer in natural language. Consequently, a larger variety of users, including lay persons, can utilize the present technology to more efficiently obtain transaction insights for a transaction through the chatbot.

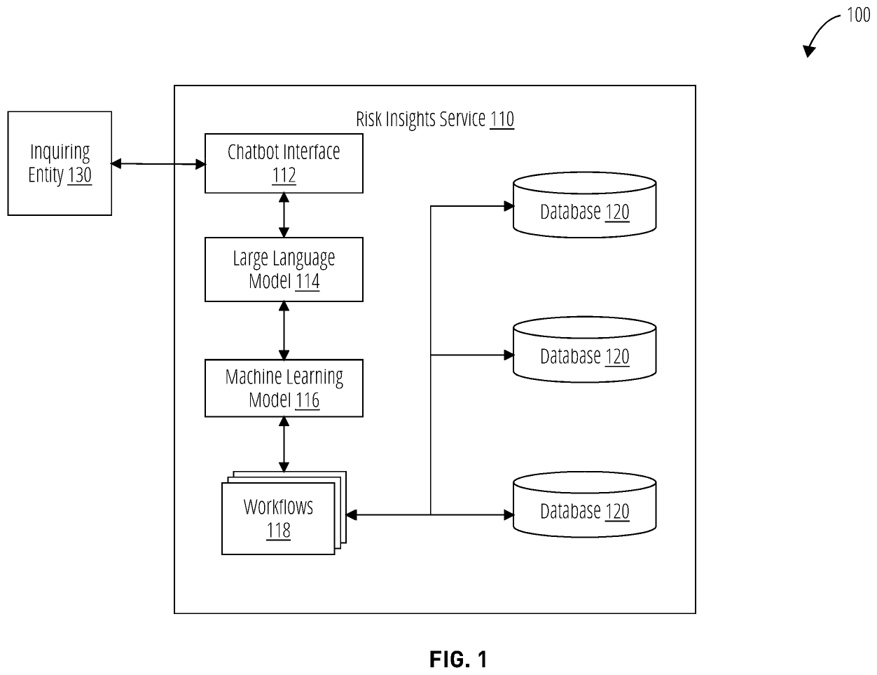

Turning now to the figures, FIG. 1 illustrates an example network environment network environment 100 having an inquiring entity 130 communicating with risk insights service 110. For example, inquiring entity 130 may be querying risk insights service 110 regarding a particular transaction and/or a particular subject entity (e.g., subject entity 206). Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The risk insights service 110 can include a chatbot interface 112, a large language model 114, a machine learning model 116, workflows 118, and databases 120.

The chatbot interface 112 is configured to receive communications from the inquiring entity 130 and provide relevant responses back to the inquiring entity 130. For example, the inquiring entity 130 may send a query or otherwise submit a question asking why a particular transaction by a subject entity was identified as a risk or otherwise associated with a particular risk score (e.g., a risk score above a threshold score). The chatbot interface 112 can be powered by the LLM or can be a standalone chatbot that can pass queries to the large language model 114 using an API. The chatbot interface 112 is configured to receive the question for the large language model 114 to interpret the question and/or an intent of the question, and provide the inquiring entity 130 with a response that answers the question. For example, the chatbot interface 112 may provide a response indicating that the transaction violated a particular rule. The response can address the query in a format that is more easily understood by a human (e.g., natural language as generated by the large language model 114).

In some embodiments, the chatbot interface 112 can be in communication with a chat interface of a partner service (e.g., partner web service 216). For example, a user of the partner service may query the chat interface of the partner service about a particular transaction. The chat interface can be configured to communicate with the chatbot interface 112 of the risk insights service 110 via one or more APIs. The large language model 114 can interpret the communications between the user and the chat interface to determine an intent of the communications and trigger a particular workflow to provide an appropriate response to the communications. In some embodiments, the large language model 114 can be trained to recognize particular intents that are associated with risk insights service 110 and to map those intents to one or more workflows 118. For example, a query or other communication can be interpreted to have an intent that is associated with why a particular transaction was not permitted or flagged. In some embodiments, the workflow can effectively be built into the large language model 114 when the large language model is trained to know what data to retrieve in response to received queries.

In some embodiments, the chatbot interface 112 can be a part of a partner service (e.g., partner web service 216), such that the chatbot interface 112 can receive communications or other queries from a user of the partner web service (e.g., subject entity 206). The chatbot interface 112 can then communicate with the large language model 114 of the risk insights service 110 to interpret the communication and proceed accordingly.

The large language model 114 is configured to interpret communications and queries. More specifically, the large language model 114 can interpret the communications and queries to determine an intent of the communication. For example, the subject entity and/or inquiring entity can ask why a transaction with a partner service failed. The large language model 114 can be configured to determine that the intent of the communication is to understand one or more reasons for an outcome of the transaction. As another example, an inquiring entity may ask about an identity of a user trying to perform a particular transaction. The large language model 114 can determine that the intent of the communication is to identify a true identity of the user attempting to perform the transaction.

In some embodiments, the large language model 114 is fine tuned based on queries, intents associated with the queries, specific types of data (e.g., stored in databases 120), etc. For example, the large language model 114 can be trained on historical queries received from subject and/or inquiring entities.

The large language model 114 enables the chatbot interface 112 to receive queries without a particular format or command by interpreting the communications. Additionally, the large language model 114 can provide responses in a format that is more easily understood by a human (e.g., in natural language) compared to conventional and rigid outputs that require extensive training and/or knowledge to interpret or otherwise understand, such as artificial language, computer code, database queries responses, API outputs, etc. Accordingly, minimal training, if any, is required to understand the responses provided through the chatbot interface 112 and users can quickly utilize the chatbot interface 112 to gain transaction insights.

In some embodiments, the large language model 114 can directly trigger or otherwise perform the one or more workflows 118. For example, the large language model 114 is configured to trigger one or more workflows 118 based on the determined and/or otherwise recognized intents.

The workflows 118 can include retrieval of data from particular databases 120. In some embodiments, the intents are mapped to particular workflows 118. For example, an intent for determining reasons for flagging a transaction can be mapped to a first workflow. The first workflow may identify particular databases. For example, the first workflow may access specific databases, such as a database for transaction histories and a database for rules determining risks in transactions. As another example, an intent for determining the identity of the user performing the transaction can be mapped to a second workflow. The second workflow can be configured to access specific machine learning models and databases, such as a machine learning model configured to determine an age, gender, and/or other identifying characteristics of a user based on device inputs and databases including account information and credentials. In other words, the workflows 118 can include or otherwise identify what types of data, sources of data, and associated processing are needed to be responsive to a query. In some embodiments, the workflows 118 can identify third-party databases that can also be searched and/or otherwise accessed (e.g., by machine learning model 116). Additionally, the workflows 118 can identify confidential information that should not be transmitted or otherwise communicated to other entities and exclude retrieval of such information. For example, the workflows 118 can include excluding confidential information to comply with legal frameworks without human error.

In some embodiments, the use of workflows to retrieve data to be summarized by the large language model 114 in the context of the query is known as retrieval augmented generation (RAG). RAG is used to retrieve relevant data and to somewhat constrain the generation of an answer provided by the large language model 114 to facts derived from the retrieved relevant data. This process can help to reduce hallucinations common to some large language models 114.

The databases 120 can be configured to store specific types of information. For example, one database can be configured to store an identity of a user with associated account credentials. As another example, another database can be configured to store transactions and transaction information (e.g., time of transaction, amount of transaction, parties of the transaction, etc.) keyed by users performing the transactions. As yet another example, another database can be configured to store rules that the risk insights service 110 uses to determine a likelihood of fraud or risk for a particular transaction and/or individual (e.g., subject entity 206).

After retrieving the data from databases 120, the machine learning model 116 can extract, based on the retrieved data, the applicable data for the query. For example, the machine learning model 116 can extract the identified transaction from the transaction history and extract a triggered rule from the rules that the risk insights service 110 uses to evaluate risk. In other words, the machine learning model 116 can determine one or more reasons for the transaction being flagged. As another example, the machine learning model 116 can extract event data for the device (e.g., mouse clicks, mouse movements, keyboard inputs, typing speed, etc.) that the user used to perform a transaction from a database storing device event data and determine the identity and/or a characteristic of the user.

After making determinations based on the data from databases 120, the determinations and/or results can be provided to large language model 114. In most cases, the data retrieved from the database 120, such as the determinations and/or results, can be in a format or syntax that can be hard to interpret by a user. The large language model 114 can then generate a response to the query from the inquiring entity 130 in a human readable format that avoids the need for a human user to interpret the underlying data. The response can be augmented by the retrieved data and/or determinations based thereon. For example, when the inquiring entity 130 asks why a particular transaction was flagged, the large language model 114 can utilize data from the database storing transaction data, rules obtained from the database storing transactional rules, and/or the determinations that the transaction violated a particular rule to generate a response identifying that the transaction violated one of the transactional rules.

In some instances, a user may want to perform a transaction through a financial service provider, such as a bank and/or a cryptocurrency exchange. The bank and/or the cryptocurrency exchange may utilize risk insights service 110 to evaluate risk, fraud, and/or identity related to one or more transactions. When the user performs the transaction, the financial service provider can send a query to the risk insights service 110 to determine the identity of the user and/or evaluate the likelihood of risk and/or fraud for the transaction. In some instances, the risk insights service 110 may provide a flag and/or a risk score. In some instances, an employee of the financial service provider may interact with the chatbot interface 112 to ascertain or otherwise get an explanation of the identified identity, risk score, and/or fraud likelihood. The chatbot interface 112 can leverage the large language model 114 to interpret the interaction by the employee. The chatbot interface 112 can utilize the interpretation and/or recognized intent from the large language model 114 to initiate and/or trigger a workflow (e.g., as performed by the machine learning model 116) to retrieve the relevant data from the appropriate databases 120. The machine learning model 116 can generate determinations based on the appropriate data and provide the data and/or determinations to the large language model 114. The large language model 114 can then generate a response augmented based on the data and/or determinations and output the response to and/or through the chatbot interface 112. The employee can then read the response in plain human language and understand the identified identity, risk score, and/or fraud likelihood and the reasons for the determinations.

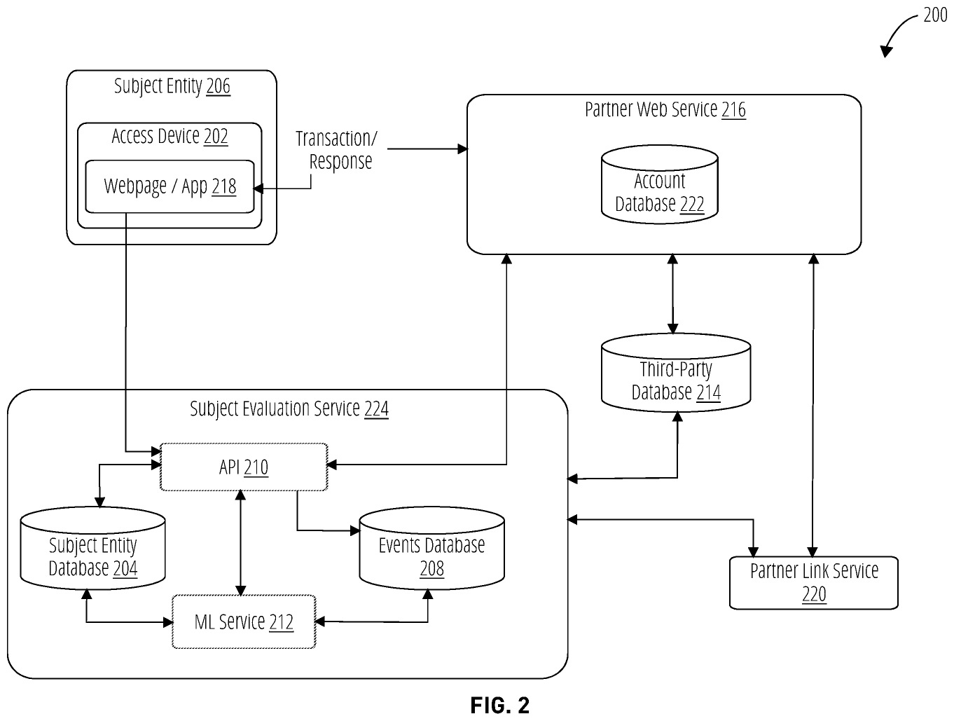

FIG. 2 illustrates an example network environment 200 for utilizing a subject evaluation service 224 to assist a partner web service 216 to evaluate transactions (e.g., including failed transactions as discussed above) by a subject entity 206 utilizing the partner web service 216. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

FIG. 2 illustrates an example network environment 200, in which a subject entity 206 utilizes an access device 202 to access a partner web service 216 associated with a partner web service 216 (e.g., a merchant, provider, payment processor, financial institution, crypto exchange, crypto wallet, etc.). In some embodiments, the partner web service 216 has a webpage/app 218 (application (app) or webpage) loaded and executing on the access device 202. The webpage/app 218 associated with the partner web service 216 can include code to report various events to API 210 of subject evaluation service 224. In some instances, the webpage/app 218 can report the events directly to API 210, and in some cases, the webpage/app 218 can report the events through partner web service 216. As will be described further herein, the events that are reported to API 210 of subject evaluation service 224 are useful in providing additional insight into the transaction regarding the likelihood that the subject entity 206 is a fraudulent party that is attempting to conduct the transaction, or other insight pertaining to the subject entity 206.

Subject entities 206 can include individuals and entities that conduct transactions. More specifically, subject entities 206 can perform or conduct on-chain transactions, off-chain transactions, and traditional transactions. On-chain transactions are transactions that occur on a blockchain that are reflected on a distributed, public ledger. On-chain transactions are typically validated and authenticated and lead to an update to the overall blockchain network. For example, a subject entity 206 may purchase a cryptocurrency on a crypto exchange. Off-chain transactions are transactions that occur outside of a blockchain. For example, a subject entity 206 may purchase a cryptocurrency wallet from another person, such that the value of the cryptocurrency is transferred to the subject entity 206, but the blockchain does not identify the transaction. Traditional transactions are transactions that are unrelated to blockchains, such as a credit card transaction at a merchant, depositing a check, an Automated Cleaning House (ACH) transaction to move money from one account to another, etc. For example, a subject entity 206 may purchase clothing with a credit card or debit card on a third-party website (e.g., a partner web service 216) that is associated with or otherwise connected to network environment 200.

As discussed above, these transactions may be denied or otherwise fail for a variety of reasons as determined by the subject evaluation service 224. When a subject entity 206 fails a transaction, it is common for the subject entity 206 to continue attempting the transaction. A user (e.g., of the partner web service 216) can ask why the transaction failed. The chatbot interface 112 is configured to receive the question, interpret the received input (e.g., using a large language model 114), and execute a workflow that retrieves the relevant data for the transaction (e.g., retrieved from subject entity database 204, events database 208, third-party database 214, and/or account database 222) and generate and provide a response to the question (e.g., using the large language model 114). Consequently, the user will be able to understand why a transaction failed with ease and without needing to submit queries in particular and/or complicated formats.

Partner web services 216 are applications, websites, and/or services for entities or platforms (e.g., merchants, service providers, payment processors, financial institutions, crypto exchanges, crypto wallets, etc.) associated with or otherwise connected to network environment 200. For example, merchants typically have a website (e.g., a partner web service 216) that people can purchase goods or access services. As another example, people typically use a website or crypto exchange service to trade cryptocurrency.

Partner web service 216 can be in communication with various databases and services. For example, partner web service 216 can have access to one or more databases maintained by partner web service 216, such as, for example, an account database 222 that stores user profiles and other account information associated with respective subject entities 206. Partner web service 216 can also communicate with and access one or more third-party databases 214 such as credit reporting databases, people search databases, social network databases, etc., to access additional information pertinent to the services provided by partner web service 216.

In some embodiments, network environment 200 can be useful to connect partner web service 216 to subject evaluation service 224 to evaluate the subject entity attempting to conduct a transaction with partner web service 216. Subject evaluation service 224 can perform its functions for many partner web services 216, and as such, it can aggregate information about the subject entity 206 as the subject entity interacts with the partner web services 216 across the Internet. Subject evaluation service 224 can build a profile to identify subject entities using behavioral data that is difficult for those committing fraud to impersonate. Subject evaluation service 224 can utilize transaction information from many partner web service 216 to train one or machine learning algorithms using ML service 212 to evaluate various transaction dimensions to determine whether the subject entity is authentic or is a fraudulent entity impersonating the subject entity.

Subject entity database 204 can store routine personal identifying information such as phone numbers, e-mails, SSNs, bank account numbers, credit card numbers, blockchain wallets, etc., and user behavior information such as typing dynamics, mouse control dynamics, access device identifying information, and more. In other words, subject entity database 204 can include various types of data that can identify and/or be linked to or associated with a particular user (e.g., subject entity 206).

In some embodiments, the subject evaluation service 224 can utilize the ML service 212 to train machine learning algorithms to evaluate other aspects of a transaction beyond whether a fraudulent entity is impersonating the subject entity 206. For example, the subject evaluation service 224 can include ML algorithms that are able to evaluate patterns in a subject entity's service usage to help evaluate transaction risks associated with a particular transaction involving the subject entity.

Application programming interface 210 (API 210) provides an interface between partner web service 216 and subject evaluation service 224 and is configured to receive event data from webpage/app 218. The event data can include a variety of information pertaining to aspects of how the subject entity 206 interacts with the webpage/app 218 (e.g., mouse movements, keyboard events, typing speed, movement of the device, etc.). In some aspects, the event data is pseudo-biometric data because a collection of such data can be used to identify a particular subject entity. API 210 is configured to record various behavioral biometrics. In some embodiments, the device events can be collected and reported by a script or algorithm deployed on webpage/app 218 that communicates directly or indirectly (through partner web service 216) with API 210 of subject evaluation service 224. In some embodiments, webpage/app 218 is further configured to stream the data (for example, while a subject entity 206 is filling out a form), or in a batch (after the subject entity 206 submits the form).

Events database 208 is configured to store the data received by API 210. In some embodiments, events database 208 is further configured to communicate with ML service 212. API 210 is configured to record biometric data (e.g., mouse movements, keyboard events, typing speed, movement of the device, etc.). In some embodiments, API 210 is called by an algorithm, script, or a software development kit (SDK) deployed on partner web service 216 and executed on or by access device 202. Additionally, API 210 is configured to asynchronously receive biometric behavioral data and/or device intelligence data. Similarly, API 210 is configured to asynchronously provide the biometric data and/or device intelligence data to events database 208. In some embodiments, API 210 is also configured to provide the data to ML service 212.

ML service 212 can be configured to receive data to train an ML model and/or to use a trained ML model to evaluate received data. More specifically, ML service 212 can be configured to receive the behavioral biometric data and/or device intelligence data from events database 208 to train the ML model or to receive data from API 210 to identify a particular user associated with the data using a trained ML model.

In some embodiments, the ML service 212 is also configured to train, host, and/or deploy a large language model. The large language model can be configured to achieve general-purpose language understanding and generation. The large language model can be a part of and/or in communication with a chatbot interface of the subject evaluation service 224. For example, a user (e.g., of an inquiring entity 302) of the subject evaluation service 224 may ask a chatbot in the chatbot interface a query regarding a particular transaction and/or subject entity 206. The large language model can receive the query from and/or through the chatbot interface and trigger a workflow based on the query. In some embodiments, the large language model can be configured to interpret an intent of the query and trigger the workflow based on the intent.

Subject entity database 204 can be the same database as events database 208 or separate. Subject entity database 204 can be configured to store information about a subject entity. For example, subject entity database 204 can store statistics regarding the behavioral biometric data and/or device intelligence data that might be used to identify a subject entity and/or the access devices that a subject entity regularly utilizes to access one or more services. Subject entity database 204 can also be configured to store conclusions of a trained ML algorithm pertaining to subject entity, such as a conclusion of the approximate age of the subject entity based on data defining attributes of how the subject entity moves a mouse or their typing speed.

In some embodiments, the subject evaluation service 224 might access one or more third-party database 214 or partner link service 220 to collect additional information to evaluate subject entity 206. One or more third-party databases 214 can include credit reporting databases, people search databases, social network databases, etc. The partner link service 220 can be a service that has access to one or more accounts of the subject entity 206, including accounts at web services other than the partner web service 216. An example of a partner link service 220 can be PLAID, by PLAID INC., which can obtain account access credentials from subject entity 206 to one or more accounts to facilitate the processing of one or more transactions on behalf of subject entity 206.

Collectively network environment 200 provides a system that facilitates a partner web service 216 to utilize evaluations made by the subject evaluation service 224 regarding the subject entity 206 to permit the partner web service 216 to decide whether to proceed with a transaction. Such evaluations might indicate that a fraudulent party is impersonating a subject entity and/or that a subject entity is attempting to perform a transaction that might come with increased risk. The subject evaluation service 224 can make these evaluations because subject evaluation service 224 tracks a subject entity and aggregates data as the subject entity performs transactions with a plurality of web services.

As discussed above, these transactions may be denied or otherwise fail for a variety of reasons as determined by the subject evaluation service 224. When a subject entity 206 fails a transaction, it is common for the subject entity 206 to continue attempting the transaction. A user (e.g., of the partner web service 216) can ask why the transaction failed. The chatbot interface 112 is configured to receive the question, interpret the received input (e.g., using a large language model 114), and execute a workflow that retrieves the relevant data for the transaction (e.g., retrieved from subject entity database 204, events database 208, third-party database 214, and/or account database 222) and generate and provide a response to the question (e.g., using the large language model 114). Consequently, the user will be able to understand why a transaction failed with ease and without needing to submit queries in particular and/or complicated formats.

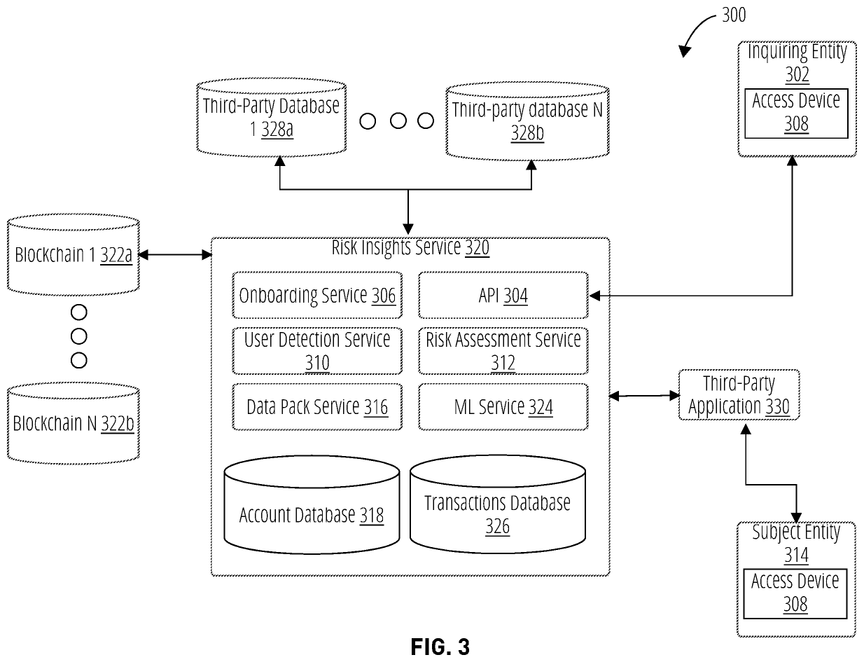

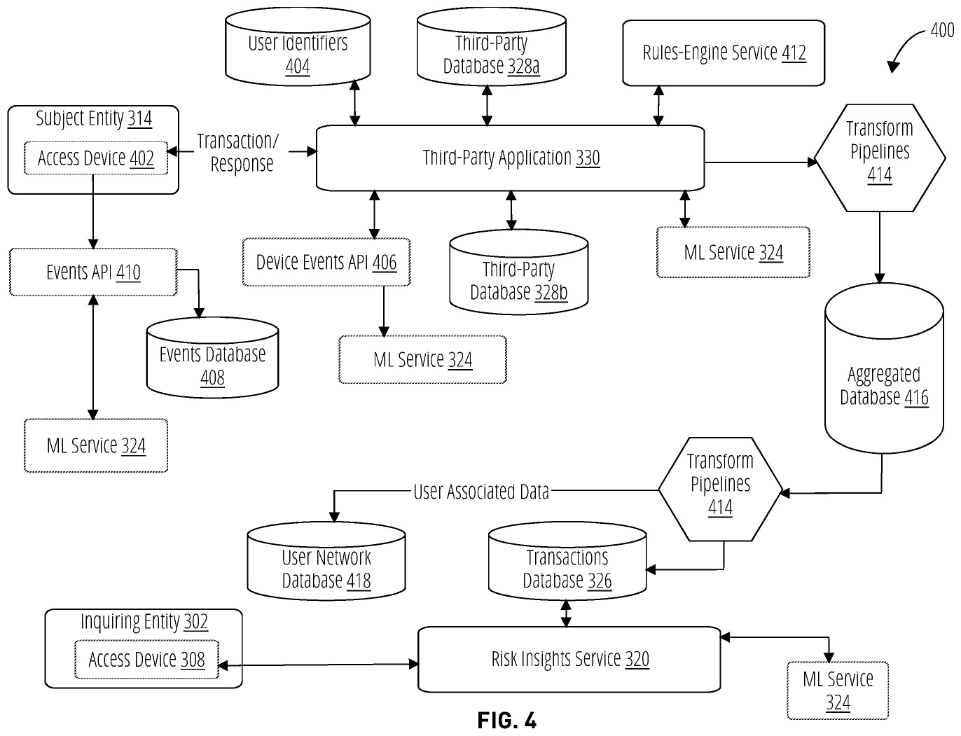

FIG. 3 and FIG. 4 illustrates example environments 300, 400 for assessing risk of a particular transaction and/or subject entity. The chatbot interface 112 discussed above can be configured to communicate with the various services of FIG. 3 and FIG. 4 to receive risk scores, transaction insights, rules, and data from the various databases. As discussed above, the chatbot interface 112 can be configured to utilize the retrieved data to provide human-understandable responses.

Turning now to FIG. 3, a network environment 300 comprises an inquiring entity 302 utilizing an access device 308, a subject entity 314 using an access device 402, a risk insights service 320, third-party databases 328a and 328b (collectively third-party databases 328), blockchains 322a and 322b (collectively blockchains 130), one or more third-party applications 330. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

Inquiring entities 302 can include entities that require information regarding a subject entity (e.g., subject entity 314). For example, an inquiring entity 302 may be a financial institution processing an application by the subject entity. As another example, an inquiring entity 302 may be a regulated institution required to monitor for potential fraud committed by the subject entity.

Subject entities 314 can include individuals and entities that conduct transactions. More specifically, subject entities 314 can perform or conduct on-chain transactions, off-chain transactions, and traditional transactions. On-chain transactions are transactions that occur on a blockchain (e.g., blockchain 322a, blockchain 322b) that are reflected on a distributed, public ledger. On-chain transactions are typically validated and authenticated and lead to an update to the overall blockchain network. For example, a subject entity 314 may purchase a cryptocurrency on a crypto exchange. Off-chain transactions are transactions that occur outside of a blockchain. For example, a subject entity 314 may purchase a cryptocurrency wallet from another person, such that the value of the cryptocurrency is transferred to the subject entity 314, but the blockchain does not identify the transaction. Traditional transactions are transactions that are unrelated to blockchains, such as a credit card transaction at a merchant, depositing a check, an Automated Cleaning House (ACH) transaction to move money from one account to another, etc. For example, a subject entity 314 may purchase clothing with a credit card or debit card on a third-party website (e.g., a third-party application 330) that is associated with or otherwise connected to network environment 200.

Third-party applications 330 are applications, websites, and/or services for entities or platforms (e.g., merchants, providers, payment processors, financial institutions, crypto exchanges, crypto wallets, etc.) associated with or otherwise connected to network environment 200. For example, merchants typically have a website (e.g., a third-party application 330) that people can purchase goods on. As another example, people typically utilize a website or service of a crypto exchange to trade cryptocurrency.

Risk insights service 320 can include various modules and services that are leveraged to receive requests or inquiries from inquiring entities 302, process requests or inquiries, select appropriate data (e.g., for specific types of legal frameworks), package the selected data into data packs, and send the data packs to inquiring entities 302. More specifically, risk insights service 320 can include an Application Programming Interface (API) 304, an onboarding service 306, a user detection service 310, a risk assessment service 312, a data pack service 316, an ML service 324, an account database 318, and one or more transactions databases 326. Although the various modules and services are shown as part of risk insights service 320, one of ordinary skill in the art would understand that the modules and services can be separate from risk insights service 320 without departing from the scope of the present disclosure. More specifically, each and every module and service can be a distinct module or service that is communication with risk insights service 320, such that risk insights service 320 can still leverage the modules and services.

API 304 is configured to interface with an access device 308 of inquiring entity 302. In some embodiments, API 304 can be configured to receive requests from inquiring entities 302. For example, API 304 can be configured to receive requests from inquiring entities 302 identifying a particular subject entity (e.g., subject entity 314). In some embodiments, the API 304 communications, calls, or requests can include different forms of information to identify the subject entity and/or the inquiring entity 302. For example, the requests or inputs can include a name, an address, an e-mail address, a phone number, a particular device, an Internet Protocol (IP) address, an account number, a routing number, card information, and/or cryptographic information (e.g., asset symbol, network, address, etc.) to identify a particular subject entity. In some embodiments, the API 304 requests can also include an inquiry period or look back period (e.g., past 90 days). API 304 can further be configured to generate a unique session key that identifies a customer identifier for the inquiring entity 302. In some embodiments, API 304 is configured to extract the customer identifier from the session key and confirm that account database 318 includes inquiring entity 302 and/or that inquiring entity 302 is permitted to access information for a use case identified in the API 304 communication. In some embodiments, API 304 is specific to an associated use case for the transaction insights, such that API 304 is configured to receive an API communication including parameters of inquiring entity data, subject entity data, access device data for an access device of the subject entity, and transaction data.

API 304 can further be configured to provide appropriate data (e.g., data packs generated by data pack service 316) to inquiring entities 302. API 304 can further be configured to receive feedback information from inquiring entities 302. The feedback information can include a decision rendered by inquiring entities 302 for a particular subject entity 314 associated with a previous inquiry. For example, the feedback information can identify that the inquiring entity 302 decided to approve an application by the subject entity 314 for a bank account. The feedback information can also identify a status of a transaction by the subject entity 314 with a particular entity. For example, an entity may identify that a transaction between the entity and the subject entity 314 was fraudulent (e.g., the subject entity 314 performed a chargeback on a credit card for a properly fulfilled transaction). Other statuses may include approval, denial, cancellation, settled, returned, disputed, fraud, suspected fraud, uncertain, and/or voided.

Onboarding service 306 is configured to onboard inquiring entities 302 to risk insights service 320. Onboarding service 306 can be configured to identify an identity of an inquiring entity 302. For example, an identifier may be associated with inquiring entity 302. An example identifier can include a routing number, an account number, an employer identification number, a name, etc. Onboarding service 306 can also be configured to look up an inquiring entity 302 using an identifier in a database (e.g., account database 318 and/or a database of regulated entities). Additionally, onboarding service 306 can be configured to assign or otherwise associate access to permitted information, permitted use cases, and/or permitted legal frameworks based on the identity of the inquiring entity 302. For example, one financial institution (e.g., an inquiring entity 302) may be associated with a permitted use case of credit checks for credit or lending decisions under FRA. As another example, a cryptocurrency exchange platform (e.g., an inquiring entity 302 that is not a recognized or regulated financial institution) may be associated with access to and/or use cases only involving publicly available information.

User detection service 310 is configured to determine a particular user (e.g., subject entity) across multiple platforms and institutions. For example, user detection service 310 is configured to collect data from user devices and generate device fingerprints (e.g., to identify a particular user device), biometric fingerprints (e.g., to identify a particular user's behavior on a webpage), and information for profiles (e.g., to recognize information belonging to a particular user). User detection service 310 can utilize device fingerprints, biometric fingerprints, and information for profiles to determine when a transaction belongs to a particular user. For example, user detection service 310 can interpret device data (e.g., a Media Access Control (MAC) address of the device, an International Mobile Equipment Identity (IMEI), etc.) and sensor data (e.g., gyroscopic data, accelerometer data, etc.) from an access device 402 (e.g., a mobile phone) of a subject entity 314 to determine an extent of movement the subject entity performs when filling in data (e.g., how much a user's hand moves or shakes). Thus, as a particular user performs a transaction, whether through traditional financial institutions (e.g., via third-party applications 330) or through blockchains 130, user detection service 310 is configured to identify the transaction as belonging to the particular user and can store the transaction in transactions database 326. In some embodiments, user detection service 310 can utilize scripts or algorithms deployed on a third-party application or website (e.g., third-party applications 330) to capture the data described above.

Risk assessment service 312 is configured to assess risk for a particular transaction. More specifically, risk assessment service 312 can be configured to access transactions databases transactions database 326 to obtain transaction data. Risk assessment service 312 can then calculate a risk score for a particular transaction. For example, risk assessment service 312 can utilize various signals including, but not limited to, transactions from a particular location, Internet Protocol (IP) address, or other device or locational fingerprints (e.g., as determined by user detection service 310) during a past time period. In some embodiments, risk assessment service 312 can utilize a machine learning model configured to receive an inquiry identifying a subject entity (e.g., subject entity 314) and output a risk score calculated based on transaction insights for the subject entity (e.g., data obtained from transactions databases 326) and/or feedback information from inquiring entities 302 (e.g., a decision later rendered by an inquiring entity 302 for a particular inquiry associated with the subject entity). In some embodiments, risk assessment service 312 can aggregate risk scores for transactions associated with a particular subject entity (e.g., subject entity 314) to generate an aggregated risk score or reputation.

Data pack service 316 is configured to collect data from transactions database 326. Based on the use case and an associated legal framework, data pack service 316 can select data from transactions database 326 to include into a data pack and provide the data pack to inquiring entity 302. In some embodiments, multiple transactions database 326 may be present, such that each transactions database 326 only includes information that is classified for one or more use cases. Thus, data pack service 316 can collect information from selected transactions databases 326 that are classified for the relevant use case and/or associated legal framework. In some embodiments, data pack service 316 can be configured to identify and provide to an inquiring entity 302 (e.g., in a data pack to inquiring entity 302) a maximum risk level (e.g., during the inquiry period), an average risk level, a maximum risk score, an average risk score, a fraud indicator (e.g., whether fraud was identified in any transaction during the inquiry period), reason codes, number of third-parties that the subject entity has used, cryptographic wallets used by the subject entity, a first usage of a third-party associated with network environment 200 (e.g., the first time that a particular subject entity uses any third-party application 330 and/or third-party website associated with or connected to network environment 200), device finger prints, behavioral biometrics, etc. Although data pack service 316 is shown in FIG. 3 as a service of risk insights service 320, it is to be understood that data pack service 316 can be a separate service from risk insights service 320. Additionally, risk insights service 320 can communicate and leverage data pack service 316 as a separate service.

ML service 324 provides the infrastructure for training and evaluating machine learning models. Using ML service 324, data scientists can prepare data sets; select, design, and train machine learning models; evaluate, refine, and deploy the models; maintain, monitor, and retrain the models; etc.

For example, training a machine learning model can include inputting past transactions into the machine learning model, inputting feedback information associated with each of the past transactions, and predicting a risk score for a particular transaction. More specifically, the feedback information can include a respective status for each of the past transactions, such that the respective status indicates whether each of the past transactions was successful, returned, or fraudulent. Then, ML service 324 can be used to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent. Although shown as a part of risk insights service 320, it is to be understood that ML service 324 can be separate from and communication with risk insights service 320.

Account database 318 can be configured to store account information for inquiring entities 302 and subject entities. For example, account database 318 can store identifiers of inquiring entities, permissions and/or use cases associated with inquiring entities 302, etc. In some embodiments, risk insights service 320 can perform a lookup on an inquiring entity 302 using an identifier associated with the inquiring entity 302 in account database 318. Additionally, account database 318 can be a database of regulated entities, such that only regulated entities are included in account database 318. In other words, an entity is a regulated entity when the entity appears in the database and the entity is not a regulated entity when the entity does not appear in the database. In some embodiments, multiple account databases 318 may be utilized, such that a first database of regulated entities is correlated with a first use case, a second database of regulated entities is correlated with a second use case, etc. Although shown as a part of risk insights service 320, it is to be understood that account database 318 can be separate from and communication with risk insights service 320. For example, risk insights service 320 can be configured to receive an API query (e.g., through API 304) from an inquiring entity 302. Risk insights service 320 can then communicate with and access account database 318 to determine whether inquiring entity 302 is a regulated entity (e.g., by attempting to match an identity of the inquiring entity with entries in account database 318 and determine a resolution therefrom).

Transactions database 326 can be configured to store transaction data for subject entities. More specifically, transactions database 326 can be configured to store both on-chain transaction data and off-chain transaction data. In some embodiments, multiple transactions databases 326 can be utilized, such that one subset of transactions databases 326 store on-chain transaction data and another subset of transactions databases 326 store off-chain transaction data. In some embodiments, transactions database 326 can collect and aggregate data from third-party databases 328 and blockchains 130. Furthermore, transactions database 326 can be configured to partition particular types of data (e.g., to prevent tainted data for a particular use case). For example, transactions database 326 may have a first partition for cryptographic transactions, a second partition for credit transactions, a third partition for cash transactions, etc. Furthermore, transactions database 326 can be configured to store various other types of data associated with subject entities including, but not limited to, the additional types discussed below, event data discussed below, etc.

Third-party databases 328 can be configured to store transaction data between a third-party (e.g., a merchant or store) and other entities (e.g., subject entities 314). For example, one merchant would have access to all transactions performed with the merchant. As another example, a credit card issuer, provider, or payment processor would have access to all transactions performed using the credit card. Third-party databases 328 can be in communication with risk insights service 320. In some embodiments, third-party databases 328 can also include additional data types associated with subject entities including, but not limited to, phone numbers, e-mail addresses, social security numbers, bank accounts, debit and/or credit card information, blockchain wallet addresses, etc. Furthermore, in some embodiments, third-party databases 328 can also store event data that extends beyond transactions. For example, third-party databases 328 can also store events performed by a subject entity including, but not limited to, linking a particular credit or debit card to an account, linking a bank account to another account, onboarding, etc. In some embodiments, third-party databases 328 are a part of risk insights service 320. In other embodiments, third-party databases 328 are separate from but in communication with risk insights service 320. Furthermore, it is to be understood that third-party databases 328 can also be and/or include third-party services. In other words, third-party databases 328 can instead be third-party services. Likewise, third-party databases 328 can include both third-party databases and third-party services.

Blockchains 130 are distributed ledgers that consists of growing lists of records that are securely linked together using cryptography. Each block in a blockchain contains a cryptographic hash of the previous block, a timestamp, and transaction data. Blockchains are used to enable cryptocurrencies, which are digital assets created using the cryptographic techniques of blockchains. Cryptocurrencies enable users to buy, sell, and/or trade the cryptocurrencies securely. Blockchains (and thus cryptocurrencies) can be accessed by crypto exchanges, in which users can exchange fiat currency for digital currency. In some embodiments, blockchains 130 are in communication with risk insights service 320. Similarly, in some embodiments, a third-party API can be utilized to gather on-chain data from blockchains 130. Additionally, risk insights service 320 can relate the on-chain data from blockchains 130 back to a particular subject entity of interest (e.g., via user detection service 310).

FIG. 4 illustrates an example network environment 400 for assisting a third-party application 330 to evaluate transactions utilizing the third-party application 330. The third-party application 330 is in communication with various services and modules shown in network environment 400. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

In network environment 400, the services and modules can be separate from, but in communication with risk insights service, such that risk insights service can still communicate with and access the various different services, modules, and stores. One of ordinary skill in the art would understand that FIG. 3, and FIG. 4 are two possible systems that can be modified without departing from the scope of the present technology. For example, some services and modules may be modified to be within risk insights service, while others are configured to be separate from risk insights service.

FIG. 4 further illustrates an example network environment 400, in which a subject entity 314 utilizes an access device 402 to access a third-party application 330 associated with a third party (e.g., a merchant, provider, payment processor, financial institution, crypto exchange, crypto wallet, etc.). In some embodiments, the third-party application 330 has an application (app) loaded and executing on the access device 402. The app associated with the third-party application 330 can include code for communicating with the third-party application 330 and code to report various events to events API 410. As will be described further herein, the events that are reported to events API 410 are useful in providing additional insight into the transaction regarding the likelihood that the subject entity 314 is a fraudulent party that is attempting to conduct the transaction, or other insight pertaining to the subject entity 314.

Subject entities 314 can include individuals and entities that conduct transactions. More specifically, subject entities 314 can perform or conduct on-chain transactions, off-chain transactions, and traditional transactions. On-chain transactions are transactions that occur on a blockchain that are reflected on a distributed, public ledger. On-chain transactions are typically validated and authenticated and lead to an update to the overall blockchain network. For example, a subject entity 314 may purchase a cryptocurrency on a crypto exchange. Off-chain transactions are transactions that occur outside of a blockchain. For example, a subject entity 314 may purchase a cryptocurrency wallet from another person, such that the value of the cryptocurrency is transferred to the subject entity 314, but the blockchain does not identify the transaction. Traditional transactions are transactions that are unrelated to blockchains, such as a credit card transaction at a merchant, depositing a check, an Automated Cleaning House (ACH) transaction to move money from one account to another, etc. For example, a subject entity 314 may purchase clothing with a credit card or debit card on a third-party website (e.g., a third-party application 330) that is associated with or otherwise connected to network environment 400.

Third-party applications 330 are applications, websites, and/or services for entities or platforms (e.g., merchants, providers, payment processors, financial institutions, crypto exchanges, crypto wallets, etc.) associated with or otherwise connected to network environment 400. For example, merchants typically have a website (e.g., a third-party application 330) that people can purchase goods on. As another example, people typically utilize a website or service of a crypto exchange to trade cryptocurrency.

Third-party application 330 can be in communication with various databases and services. For example, third-party application can access one or more third-party databases 328a, access user identifiers 404, include, deploy, and/or access a device events API 406, utilize and/or access a rules-engine service 412, utilize and/or access an ML service 324, and communicate with transform pipelines 414, etc.

As discussed above, third-party databases 328a can be configured to store transaction events occurring at third-party application 330 (e.g., the website or mobile application of the third-party). For example, third-party databases 328a can be configured to store transaction events including, but not limited to, linking a card to an account with the third-party, linking a bank account to an account with the third-party, onboarding or activating an account with the third-party. In some embodiments, third-party databases 328a can be online aggregations of transactions occurring across multiple third parties.

User identifiers 404 can be stored in a database (e.g., third-party databases 328a). User identifiers 404 can include phone numbers, e-mails, SSNs, bank account number, credit card number, blockchain wallets, etc. In other words, user identifiers 404 can include various different types of data that can identify and/or be linked to or associated with a particular user (e.g., subject entity 314).

Device events API 406 is configured to record biometric data (e.g., mouse movements, keyboard events, typing speed, movement of the device, etc.) while a subject entity 314 interacts with third-party application 330. In other words, device events API 406 is configured to record various device intelligence logics for behavioral biometrics. In some embodiments, device events API 406 can be a script or algorithm deployed on third-party application 330 that communicates with a user detection service (e.g., user detection service 310 as described above with respect to FIG. 3). In some embodiments, device events API 406 can perform the functions of user detection service 310. Device events API 406 is further configured to provide data synchronously submitted to third-party application 330. For example, a subject entity 314 may be filling out a form. Device events API 406 can be configured to provide the recorded data, along with any inputted data (e.g., any data input into the form), to ML service 324 and/or an events database 408.

Events database 408 is configured to store the data recorded by device events API 406 and events API 410. In some embodiments, events database 408 is further configured to communicate with (e.g., send data to) user detection service 310.

Events API 410 is configured to record biometric data (e.g., mouse movements, keyboard events, typing speed, movement of the device, etc.). In some embodiments, events API 410 is an algorithm, script, or a software development kit (SDK) deployed on third-party application 330 and executed on or by access device 402. Additionally, events API 410 is configured to asynchronously receive biometric behavioral data and/or device intelligence data. Similarly, events API 410 is configured to asynchronously provide the biometric data and/or device intelligence data to events database 408. In some embodiments, events API 410 is also configured to provide the data to user detection service 310.

As described above, ML service 324 can be configured to receive data to train a ML model. More specifically, ML service 324 can be configured to receive the behavioral biometric data and/or device intelligence data (e.g., from device events API 406 and/or events API 410) to identify a particular user associated with the data. In some embodiments, the ML service 324 can be configured to support or be utilized by user detection service 310.

Rules-engine service 412 is configured to select, change, and/or provide rules that identify specific types of data that are utilized to identify a particular subject entity 314. Furthermore, rules-engine service 412 can provide rules that associate each type of data with a particular weight for determining a particular subject entity 314. For example, a first rule may associate a first weight for an IP address associated with access device 402 of subject entity 314, while a second rule may associate a second weight for biometric behavioral data (e.g., data obtained from device events API 406), such that the second weight is lower, higher, or the same weight as the first weight. Additionally, rules-engine service 412 can provide rules that identify whether a particular transaction is likely to be fraudulent. For example, a rule may identify that abnormally frequent low transactions (e.g., a series of $2 transaction at a convenience store) and/or abnormally high transactions at particular merchants (e.g., $1,000 at a convenience store) may be indicators that the transaction is likely fraudulent. In some embodiments, rules-engine service 412 can be configured to generate new rules. In some embodiments, rules-engine service 412 can also be configured to receive input from third parties (e.g., merchants, providers, etc.) to automatically generate new rules. For example, a particular merchant may identify that a significantly high number of fraudulent transactions appear to originate from a particular country. Thus, rules-engine service 412 may generate a rule that assigns a higher weight to data types indicative of geographical location (e.g., IP address, time of accessing third-party application 330, etc.).

Transform pipelines 414 are configured to transform data received from third-party applications 330 (e.g., to be properly stored in a database, to be utilized for machine learning, and/or to be provided to an inquiring entity). In some embodiments, transform pipelines 414 are configured to transform data to be stored in an aggregated database 416. In some embodiments, transform pipelines are configured to transform data to be stored in user network database 418 and/or transactions database 326.

Aggregated database 416 is configured to aggregate and store data from third-party applications 330. In other words, aggregated database 416 is configured to store data from multiple merchants, providers, payment processors, financial institutions, crypto exchanges, crypto wallets, etc. In some embodiments, aggregated database 416 can be a third-party database.

User network database 418 is configured to store user associated data. For example, user network database 418 can store various types of information associated with a particular subject entity 314. More specifically, user network database 418 can store and associate entity level device information, behavior biometrics, on-chain transaction data, off-chain transaction data, traditional transaction data, blockchain wallet addresses, and other customer information with a particular subject entity 314.

Similarly and as discussed above, transactions database 326 is configured to store transaction information. For example, transactions database 326 can be configured to store transaction data for subject entities. More specifically, transactions database 326 can be configured to store both on-chain transaction data and off-chain transaction data.

Furthermore, user network database 418 and transactions database 326 can be configured to partition particular types of data (e.g., to prevent tainted data for a particular use case). For example, transactions database 326 may have a first partition for cryptographic transactions, a second partition for credit transactions, a third partition for cash transactions, etc.

As discussed above, risk insights service 320 is configured to receive an API query from an access device 308 of an inquiring entity 302 and provide an API response. Risk insights service 320 can access appropriate data (e.g., for a use case identified in the API query and/or under a particular legal framework associated with the use case) in user network database 418 and transactions database 326, generate a data pack (e.g., using a ML model from ML service 324 and/or data pack service 316) with the appropriate data, and provide the data pack back to inquiring entity 302 in an API response.

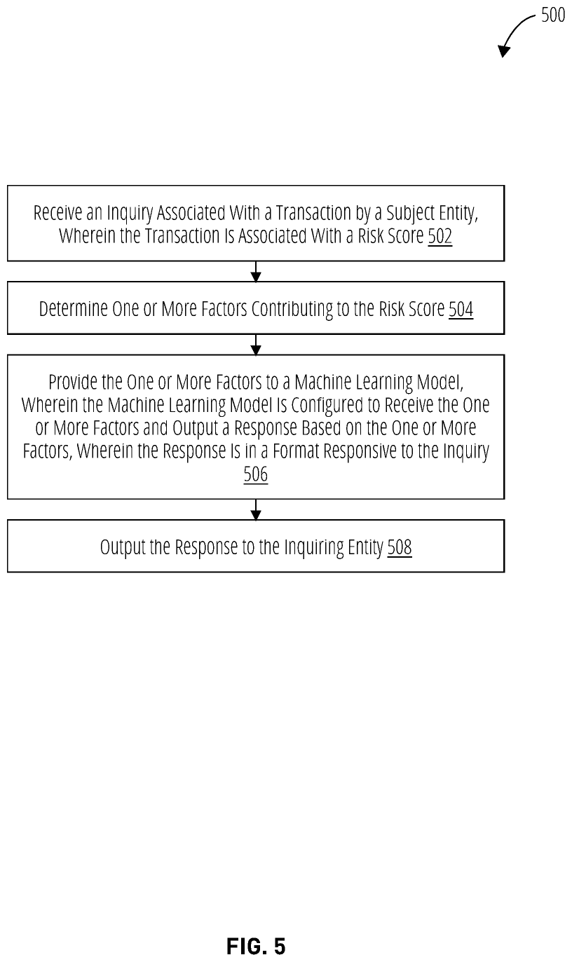

FIG. 5 illustrates an example method 500 for providing risk insights and/or other responses augmented by retrieved and/or interpreted data. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

At step 502, method 500 receives, by a risk insights system from an inquiring entity, an inquiry associated with a transaction by a subject entity, wherein the transaction is associated with a risk score. In some embodiments, receiving the inquiry is performed by a large language model trained based on queries associated with transactions from a transaction database of the risk insights system. In some embodiments, the large language model receives the inquiry through a chatbot interface. In some embodiments, the large language model is trained to determine an intent of the inquiry and, based on determining the intent, trigger a workflow to determine one or more factors contributing to the risk score. In some embodiments, the inquiry identifies a time range and the transaction was performed during the time range. In some embodiments, the transaction is an anomaly compared to other transactions performed by the subject entity during the time range. For example, the transaction may be performed from an Internet Protocol (IP) address that is different from a typical IP address that the user performed other transactions from.

In some embodiments, method 500 can include fetching, by the risk insights system, identifying information about the subject entity. For example, the risk insights system can fetch a name, age, gender, location, associated account, and/or other identifying information about the subject entity.

In some embodiments, method 500 can include determining, by the risk insights system, that the identifying information about the subject entity is not stored in a database of the risk insights system. In some embodiments, method 500 can include returning, by the risk insights system, an error to the inquiring entity indicating that a user identifier does not exist for the subject entity in the database.

In some embodiments, method 500 can include searching, by the risk insights system, one or more third party databases for additional information based on the identifying information about the subject entity.

At step 504, method 500 determines, by the risk insights system, one or more factors contributing to the risk score. In some embodiments, determining the one or more factors includes extracting, by the risk insights system, a rule and a transaction identifier for the transaction. In some embodiments, determining the one or more factors includes extracting, by the risk insights system, rule details for the rule from a rule database of the risk insights system. In some embodiments, determining the one or more factors includes extract, by the risk insights system, transaction details for the transaction from a transaction database of the risk insights system based on the transaction identifier. In some embodiments, the transaction details include at least one of a transaction amount value or a country associated with the transaction.

At step 506, method 500 provides, by the risk insights system, the one or more factors to a machine learning model, wherein the machine learning model is configured to receive the one or more factors and output a response based on the one or more factors, wherein the response is in a format responsive to the inquiry. In some embodiments, the response is formatted by a large language model to be in a format responsive to the inquiry.

At step 508, method 500 output, by the risk insights system, the response to the inquiring entity. In some embodiments, the response is provided to the inquiring entity by a large language model. In some embodiments, the response is provided to the inquiring entity by a chatbot interface.

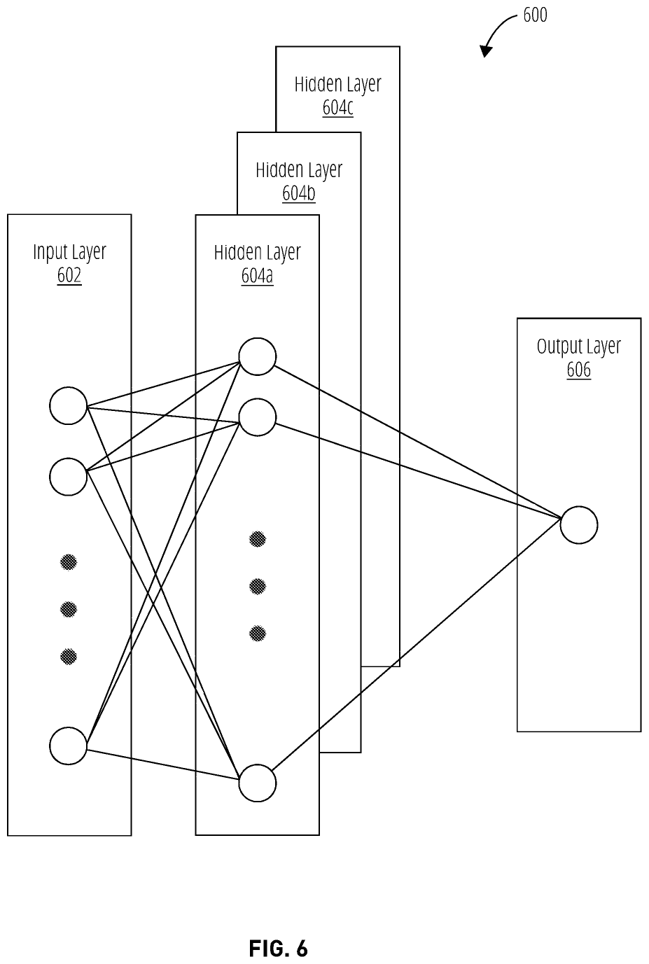

In FIG. 6, the disclosure now turns to a further discussion of models that can be used through the environments and techniques described herein. Specifically, FIG. 6 is an illustrative example of a deep learning neural network 600 that can be used to implement all or a portion of a perception module (or perception system) as discussed above. An input layer 602 can be configured to receive sensor data and/or data relating to an environment surrounding an AV. The neural network 600 includes multiple hidden layers 604a, 604b, through 604c. The hidden layers 604a through 604c include “n” number of hidden layers, where “n” is an integer greater than or equal to one. The number of hidden layers can be made to include as many layers as needed for the given application. The neural network 600 further includes an output layer 606 that provides an output resulting from the processing performed by the hidden layers 604a through 604c. In one illustrative example, the output layer 606 can provide estimated treatment parameters, that can be used/ingested by a differential simulator to estimate a patient treatment outcome.

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 602 can activate a set of nodes in the first hidden layer 604a. For example, as shown, each of the input nodes of the input layer 602 is connected to each of the nodes of the first hidden layer 604a. The nodes of the first hidden layer 604a can transform the information of each input node by applying activation functions to the input node information. The information derived from the transformation can then be passed to and can activate the nodes of the next hidden layer 604b, which can perform their own designated functions. Example functions include convolutional, up-sampling, data transformation, and/or any other suitable functions. The output of the hidden layer 604b can then activate nodes of the next hidden layer, and so on. The output of the last hidden layer 604c can activate one or more nodes of the output layer 606, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 602 using the different hidden layers 604a through 604c in order to provide the output through the output layer 606.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target−output)\hat{ }2) The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

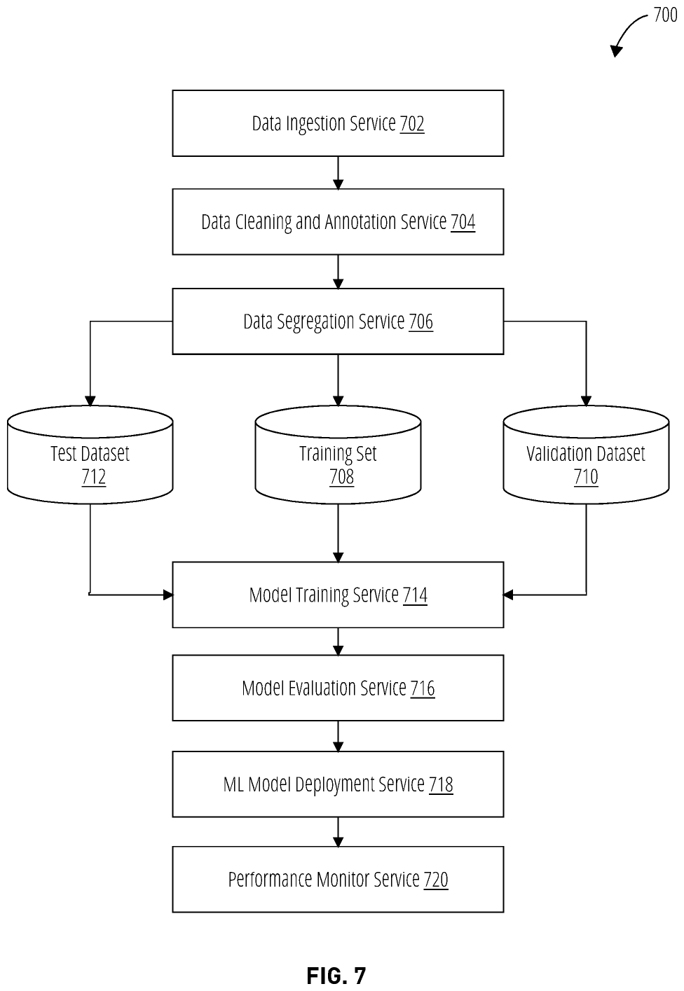

FIG. 7 illustrates an example lifecycle 700 of a ML model in accordance with some examples. The first stage of the lifecycle 700 of a ML model is a data ingestion service 702 to generate datasets described below. ML models require a significant amount of data for the various processes described in FIG. 7 and the data persisted without undertaking any transformation to have an immutable record of the original dataset. The data can be provided from third party sources such as publicly available dedicated datasets. The data ingestion service 702 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 702 retrieves the data. In some examples, the data ingestion service 702 may be online and the data is streamed from the producer in real-time for storage in the data ingestion service 702.

After data ingestion service 702, a data preprocessing service preprocesses the data to prepare the data for use in the lifecycle 700 and includes at least data cleaning, data transformation, and data selection operations. The data cleaning and annotation service 704 removes irrelevant data (data cleaning) and general preprocessing to transform the data into a usable form. The data cleaning and annotation service 704 includes labelling of features relevant to the ML model. In some examples, the data cleaning and annotation service 704 may be a semi-supervised process performed by a ML to clean and annotate data that is complemented with manual operations such as labeling of error scenarios, identification of untrained features, etc.

After the data cleaning and annotation service 704, data segregation service 706 to separate data into at least a training set 708, a validation dataset 710, and a test dataset 712. Each of the training set 708, a validation dataset 710, and a test dataset 712 are distinct and do not include any common data to ensure that evaluation of the ML model is isolated from the training of the ML model.

The training set 708 is provided to a model training service 714 that uses a supervisor to perform the training, or the initial fitting of parameters (e.g., weights of connections between neurons in artificial neural networks) of the ML model. The model training service 714 trains the ML model based a gradient descent or stochastic gradient descent to fit the ML model based on an input vector (or scalar) and a corresponding output vector (or scalar).

After training, the ML model is evaluated at a model evaluation service 716 using data from the validation dataset 710 and different evaluators to tune the hyperparameters of the ML model. The predictive performance of the ML model is evaluated based on predictions on the validation dataset 710 and iteratively tunes the hyperparameters based on the different evaluators until a best fit for the ML model is identified. After the best fit is identified, the test dataset 712, or holdout data set, is used as a final check to perform an unbiased measurement on the performance of the final ML model by the model evaluation service 716. In some cases, the final dataset that is used for the final unbiased measurement can be referred to as the validation dataset and the dataset used for hyperparameter tuning can be referred to as the test dataset.

After the ML model has been evaluated by the model evaluation service 716, an ML model deployment service 718 can deploy the ML model into an application or a suitable device. The deployment can be into a further test environment such as a simulation environment, or into another controlled environment to further test the ML model.

After deployment by the ML model deployment service 718, a performance monitor service 720 monitors for performance of the ML model. In some cases, the performance monitor service 720 can also record additional transaction data that can be ingested via the data ingestion service 702 to provide further data, additional scenarios, and further enhance the training of ML models.

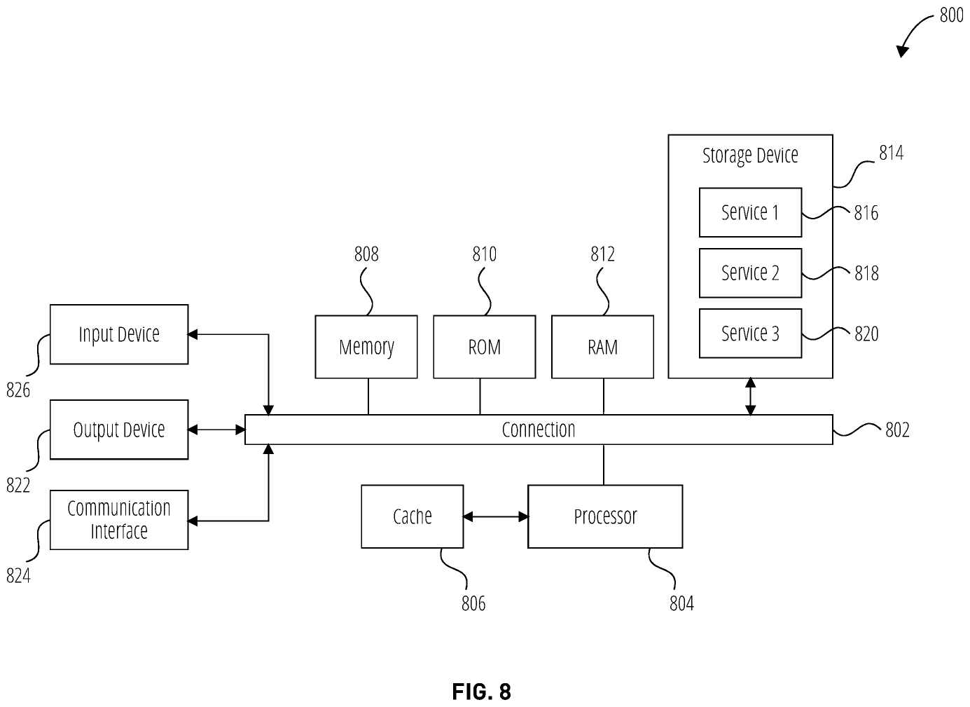

FIG. 8 shows an example of computing system 800, which can be for example any computing device making up access devices, services, orchestration systems, client devices and/or APIs, exchange platforms, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804.

Processor 804 can include any general purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method for providing risk insights, the method comprising:
receiving, by a risk insights system from an inquiring entity, an inquiry associated with a transaction by a subject entity, wherein the transaction is associated with a risk score;
determining, by the risk insights system, one or more factors contributing to the risk score;
providing, by the risk insights system, the one or more factors to a machine learning model, wherein the machine learning model is configured to receive the one or more factors and output a response based on the one or more factors, wherein the response is in a format responsive to the inquiry; and
outputting, by the risk insights system, the response to the inquiring entity.

2. The computer-implemented method of claim 1, wherein receiving the inquiry and outputting the response is performed by a large language model trained based on queries associated with transactions from a transaction database of the risk insights system.

3. The computer-implemented method of claim 2, wherein the large language model receives the inquiry and outputs the response through a chatbot interface.

4. The computer-implemented method of claim 2, wherein the large language model is further trained to determine an intent of the inquiry and, based on determining the intent, trigger a workflow to determine the one or more factors.

5. The computer-implemented method of claim 1, wherein determining the one or more factors contributing to the risk score includes:
extracting, by the risk insights system, a rule and a transaction identifier for the transaction;
extracting, by the risk insights system, rule details for the rule from a rule database of the risk insights system; and
extracting, by the risk insights system, transaction details for the transaction from a transaction database of the risk insights system based on the transaction identifier.

6. The computer-implemented method of claim 5, wherein the transaction details include at least one of a transaction amount value or a country associated with the transaction.

7. The computer-implemented method of claim 1, wherein the inquiry identifies a time range, and wherein the transaction was performed during the time range.

8. The computer-implemented method of claim 7, wherein the transaction is an anomaly compared to other transactions performed by the subject entity during the time range.

9. The computer-implemented method of claim 1, further comprising:
fetching, by the risk insights system, identifying information about the subject entity.

10. The computer-implemented method of claim 9, further comprising:
determining, by the risk insights system, that the identifying information about the subject entity is not stored in a database of the risk insights system; and
returning, by the risk insights system, an error to the inquiring entity indicating that a user identifier does not exist for the subject entity in the database.

11. The computer-implemented method of claim 9, further comprising:
searching, by the risk insights system, one or more third party databases for additional information based on the identifying information about the subject entity.

12. A non-transitory computer-readable medium storing instructions thereon, wherein the instructions, when executed by one or more processors, cause the one or more processors to perform operations comprising:
receiving, by a risk insights system from an inquiring entity, an inquiry associated with a transaction by a subject entity, wherein the transaction is associated with a risk score;
determining, by the risk insights system, one or more factors contributing to the risk score;
providing, by the risk insights system, the one or more factors to a machine learning model, wherein the machine learning model is configured to receive the one or more factors and output a response based on the one or more factors, wherein the response is in a format responsive to the inquiry; and
outputting, by the risk insights system, the response to the inquiring entity.

13. The non-transitory computer-readable medium of claim 12, wherein receiving the inquiry and outputting the response is performed by a large language model trained based on queries associated with transactions from a transaction database of the risk insights system.

14. The non-transitory computer-readable medium of claim 13, wherein the large language model receives the inquiry and outputs the response through a chatbot interface.

15. The non-transitory computer-readable medium of claim 13, wherein the large language model is further trained to determine an intent of the inquiry and, based on determining the intent, trigger a workflow to determine the one or more factors.

16. The non-transitory computer-readable medium of claim 12, wherein determining the one or more factors contributing to the risk score includes:
extracting, by the risk insights system, a rule and a transaction identifier for the transaction;
extracting, by the risk insights system, rule details for the rule from a rule database of the risk insights system; and
extracting, by the risk insights system, transaction details for the transaction from a transaction database of the risk insights system based on the transaction identifier.

17. The non-transitory computer-readable medium of claim 16, wherein the transaction details include at least one of a transaction amount value or a country associated with the transaction.

18. A system comprising:
a processor; and
a non-transitory memory storing computer-executable instructions thereon, wherein the computer-executable instructions, when executed by the processor, cause the processor to perform operations comprising:
receiving, by a risk insights system from an inquiring entity, an inquiry associated with a transaction by a subject entity, wherein the transaction is associated with a risk score;
determining, by the risk insights system, one or more factors contributing to the risk score;
providing, by the risk insights system, the one or more factors to a machine learning model, wherein the machine learning model is configured to receive the one or more factors and output a response based on the one or more factors, wherein the response is in a format responsive to the inquiry; and
outputting, by the risk insights system, the response to the inquiring entity.

19. The system of claim 18, wherein the inquiry identifies a time range, and wherein the transaction was performed during the time range.

20. The system of claim 19, wherein the transaction is an anomaly compared to other transactions performed by the subject entity during the time range.
